(19) United States
(12) Patent Application Publication
(10) Pub. No.: US 2024/0303508 A1
(43) Pub. Date: Sep. 12, 2024

(54) DETECTING ACTIONS IN VIDEO USING MACHINE LEARNING AND BASED ON BIDIRECTIONAL FEEDBACK BETWEEN PREDICTED TYPE AND PREDICTED EXTENT

(71) Applicant: International Business Machines Corporation, Armonk, NY (US)

(72) Inventors: Bo WU, Cambridge, MA (US); Chuang GAN, Cambridge, MA (US); Kaizhi QIAN, Champaign, IL (US); Pin-Yu CHEN, White Plains, NY (US)

(21) Appl. No.: 18/180,721

(22) Filed: Mar. 8, 2023

(51) Int. Cl. G06N 5/022

(52) U.S. Cl. CPC G06N 5/022

(57) ABSTRACT

Techniques of video processing for action detection using machine learning. An action depicted in a video is identified. A type of the action is predicted based on a classification module of one or more machine learning models. A video clip depicting the action is predicted in the video. To that end, a starting point and an ending point of the video clip in the video are determined. The video clip is predicted based on a localization module of the one or more machine learning models. A refinement is performed that includes refining the type of the action based on the video clip or refining the video clip based on the type of the action. An indication of the refined type or of the refined video clip is output.

### BACKGROUND

Embodiments presented in this disclosure relate to techniques for video processing for action detection using machine learning. More specifically, embodiments disclosed herein relate to action detection based on a bidirectional feedback mechanism between a predicted action type and a predicted time extent of an action depicted in a video.

In the current age of digital video content, it is often time-consuming for a user to find a specific scene or reference within a video when doing so requires the user to watch a majority of the video or to expend time manually searching the video content. Even after searching, a user may not know if relevant scenes or references within the video content were missed. Likewise, some video content may be inappropriate for viewing at particular locations, such as the workplace. It may be helpful for a user to know beforehand the content of specific video scenes before playing them.

### SUMMARY

Embodiments presented in this disclosure provide a computer-implemented method, a computer program product, and a system to perform an operation of video processing for action detection using machine learning. The operation includes identifying the action depicted in the video. The video includes one or more images. A type of the action is predicted based on a classification module of one or more machine learning models. A video clip depicting the action is predicted in the video. Predicting the video clip includes determining a starting point and an ending point of the video clip in the video. The video clip is predicted based on a localization module of the one or more machine learning models. A refinement is performed that includes at least one of refining the type of the action based on the video clip or refining the video clip based on the type of the action. An indication of the refined type or of the refined video clip is output.

### BRIEF DESCRIPTION OF THE DRAWINGS

FIG. 1 depicts types and time extents predicted for actions depicted in a video, according to one embodiment presented in this disclosure.

FIGS. 2A-2B depict the type and the time extent predicted for the depicted action, where each of the type and of the time extent are refined based on the other, according to one embodiment presented in this disclosure.

FIG. 3 is a block diagram depicting components of an application for action detection using machine learning, according to one embodiment presented in this disclosure.

FIGS. 4A-4B depict components that enable a bidirectional feedback mechanism between a predicted action type and a predicted time extent for the depicted action, according to one embodiment presented in this disclosure.

FIG. 5 is a flowchart depicting a method of video processing for action detection using machine learning, according to one embodiment presented in this disclosure.

FIG. 6 is a block diagram illustrating components of a computing environment for video processing for action detection using machine learning, according to one embodiment.

### DETAILED DESCRIPTION

Embodiments presented in this disclosure provide techniques for video processing for action detection using machine learning. One embodiment provides an application that performs action detection using machine learning and based on a bidirectional feedback mechanism between application components configured to determine, respectively, a predicted action type and a predicted time extent of an action depicted in a video. The application components are of the application and are also referred to herein as components modules of the application. At least in some cases, presence of the bidirectional feedback mechanism can result in higher measures of accuracy of results obtained from performing the action detection.

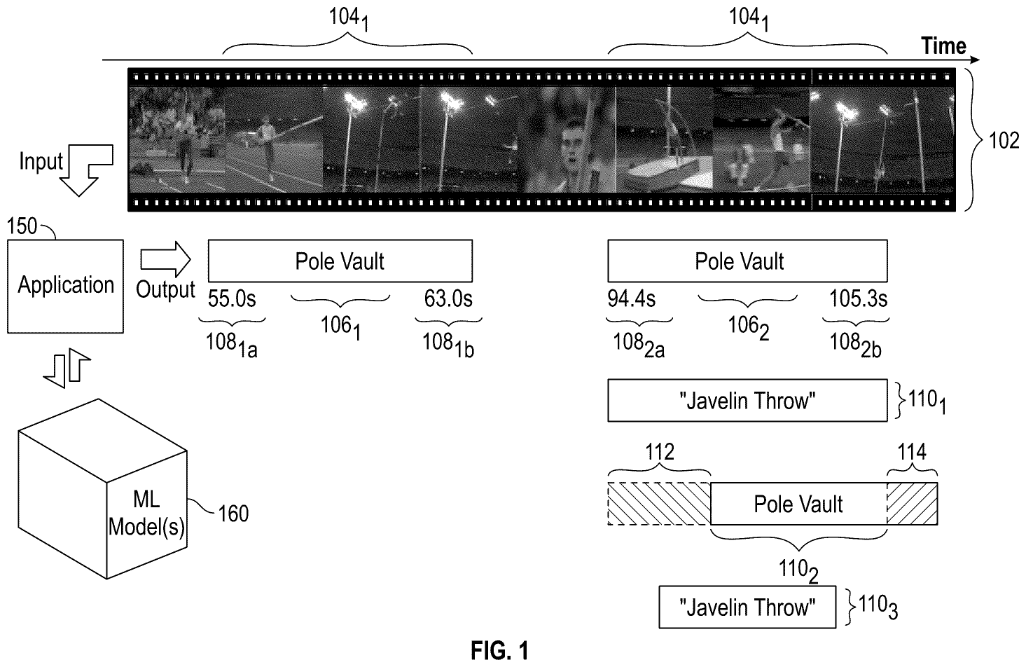

FIG. 1 depicts types 106₁₋₂ and time extents 108₁₋₂ predicted for actions 104 depicted in a video 102, according to one embodiment presented in this disclosure. The actions 104 can be referred to as actions for which classification and/or temporal localization are desired, or desired actions for short. At least in some embodiments, the video 102 segments depicting the desired actions and further segments that do not depict the desired actions. Such a video can be referred to as an untrimmed video because the video has not been trimmed to exclude the further segments that do not depict the desired actions. Further, although the video 102 is described herein as depicting one or more sporting events, other types of content of the video 102 are broadly contemplated.

One embodiment provides an application 150 that takes the video 102 as input and determines, using one or more machine learning models 160, output in the form of the types 106₁₋₂ and time extents 108₁₋₂ for the desired actions 104 that are depicted in the video 102. To that end, the application 150 performs one or more predefined operations that can include, for each desired action, classifying the respective action and temporally localizing the respective action in the video. These included operations can also be jointly referred to as temporal action localization by the application 150.

At least in some embodiments, although the included operations can be performed by the application 150, results obtained from performing the included actions may not necessarily be correct or accurate. For example, an inaccurate classification of the desired action can erroneously designate the desired action as being a first action type when the desired action is really of a second action type that is different from the first action type. For instance, an output 1101 that can result reflects an incorrect classification of a pole vault, depicted in the video, as being a javelin throw—even though the output 1101 reflects a correct temporal localization of the pole vault.

Additionally or alternatively to the classification being inaccurate, the temporal localization of the desired action can be inaccurate. For example, an inaccurate temporal localization of a desired action can yield a time extent that either erroneously excludes at least a portion of a video segment depicting the desired action, if the time extent is too narrow in extent as to exclude a time extent that should have been included. For instance, an output 110₂ reflects an inaccurate temporal localization of the desired action even though the output 110₂ reflects a correct classification of the pole vault. Associated with the output 110₂ is a time extent 112 constitutes an erroneously excluded time extent for the pole vault.

Additionally or alternatively, the yielded time extent can erroneously include at least a portion of an extraneous video segment, if the time extent is too broad in extent as to include a time extent that should have been excluded. For instance, associated with the output 110₂ is a time extent 114 constitutes an erroneously included time extent for the pole vault depicted in the video even though the output 110₂ reflects the correct classification of the pole vault. In a worst-case scenario, an entirely of the time extent excludes altogether the video segment depicting the desired action while including only one or more video segments that are extraneous.

To show both inaccurate classification and inaccurate temporal localization in a single, further example, an output 110₃ reflects an inaccurate classification of the pole vault as being a javelin throw and further erroneously excludes time extents that are proximate to both the beginning and end of the pole vault, respectively.

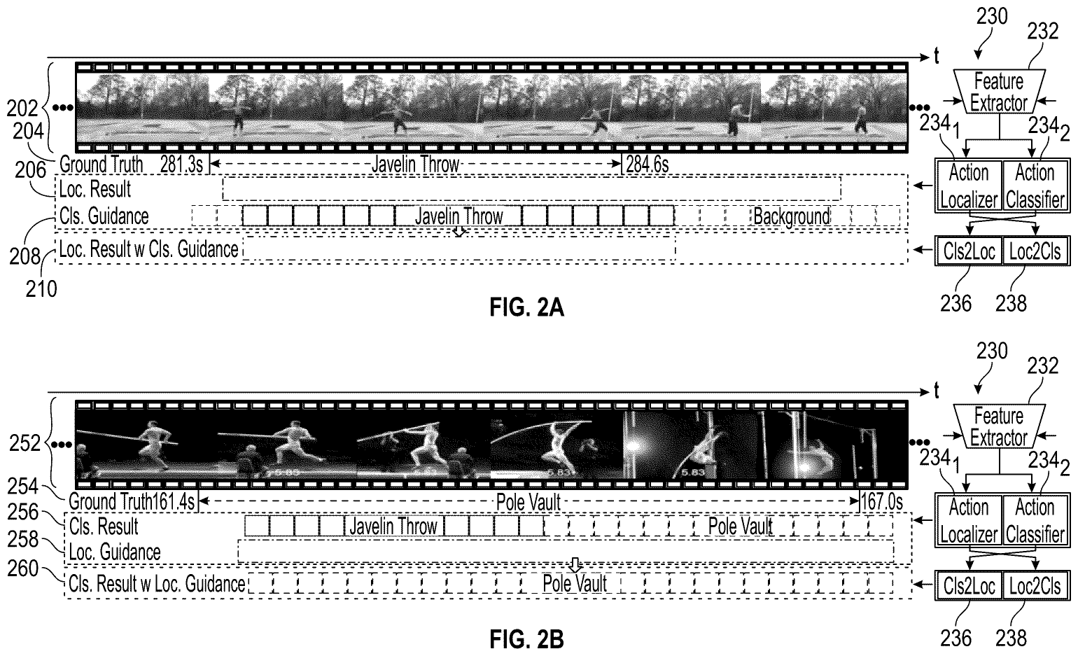

FIGS. 2A-2B depict the type and the time extent predicted for the depicted action, where each of the type and of the time extent are refined based on the other, according to one embodiment presented in this disclosure. As shown in FIG. 2A, a video 202 includes a video segment depicting a javelin throw during a time extent defined by a starting timestamp and an ending timestamp. In this particular example, the starting timestamp is two hundred and eighty-one and three-tenths seconds from a reference point of the video 202 such as a beginning of the video 202. The ending timestamp is two hundred and eighty-four and six-tenths seconds from the reference point of the video 202. The reference points used by the starting and ending timestamps can be the same reference point or different reference points, depending on the embodiment. The actual information regarding the video segment depicting the javelin throw and further regarding the time extent of the video segment can be referred to as true answers, or ground truths 254, at least in the context of operations involving the one or more machine learning models. The operations include, without limitation, training, validating, applying, refining, and evaluating the one or more machine learning models.

In the absence of bidirectional feedback, the application can determine a temporal localization 206, of the javelin throw, that is inaccurate because the temporal localization includes extraneous content both before and after the javelin throw. In addition, the application can determine a classification 208 of the javelin throw as being a javelin throw. In some embodiments, the classification 208 is made available to the application via the bidirectional feedback mechanism between application components for temporal localization and action classification, respectively.

With bidirectional feedback, the application can use the classification 208 as input to generate a refined temporal localization 210. Bidirectional feedback is also referred to herein as complementary interaction, each task representing a different type of prediction being generated, e.g., a type and a time extent of the depicted action. The complementary interaction includes complementary information provided by each of the two tasks to the other task. For instance, initial localization results can be used to refine initial classifications that can misclassify similar and substantially sequential actions as being a single, overall action. Further, initial classification results can be used to refine initial localizations that incorrectly localize segments. The initial results can also be referred to as preliminary results. The segments can be incorrectly localized due to the localization component being misled by certain visual features, in the video, that have a low degree of distinguishability by the localization component.

In one embodiment, unlike the temporal localization 206, the refined temporal localization 210 reflects a temporal localization, of the javelin throw, that is accurate when measured against the ground truth. Depending on the embodiment, the refinement of the temporal localization can be performed either as an explicit operation or as an implicit operation, by the application. If the refinement is performed as an implicit operation, the application determines, in a single determination, the refined temporal localization 210 without first explicitly determining the temporal localization 206. Similarly, the classification 208 that is used as input can be either an explicit classification or an implicit classification, depending on the embodiment.

To generate the refined temporal localization 210, the application can include one or more machine learning models, which can in turn include components 230, according to one embodiment. Further, the components 230 can include an attention mechanism. The attention mechanism is included to facilitate aggregating, in a reciprocal manner, localization and classification notwithstanding their heterogeneous nature relative to one another.

As shown, the components 230 include a feature extractor 232, an action localizer 234₁, an action classifier 234₂, a classification-to-localization (“Cls2Loc”) attention module 236, and a localization-to-classification (“Loc2Cls”) attention module 238. These attention modules constitute the attention mechanism and are also referred to herein as feedback components. The feature extractor 232 extracts features from the video 202. Further, the action localizer 234₁ generates initial and refined time-extent predictions based on the extracted features. The action classifier 234₂ generates initial and refined action-type classifications based on the extracted features.

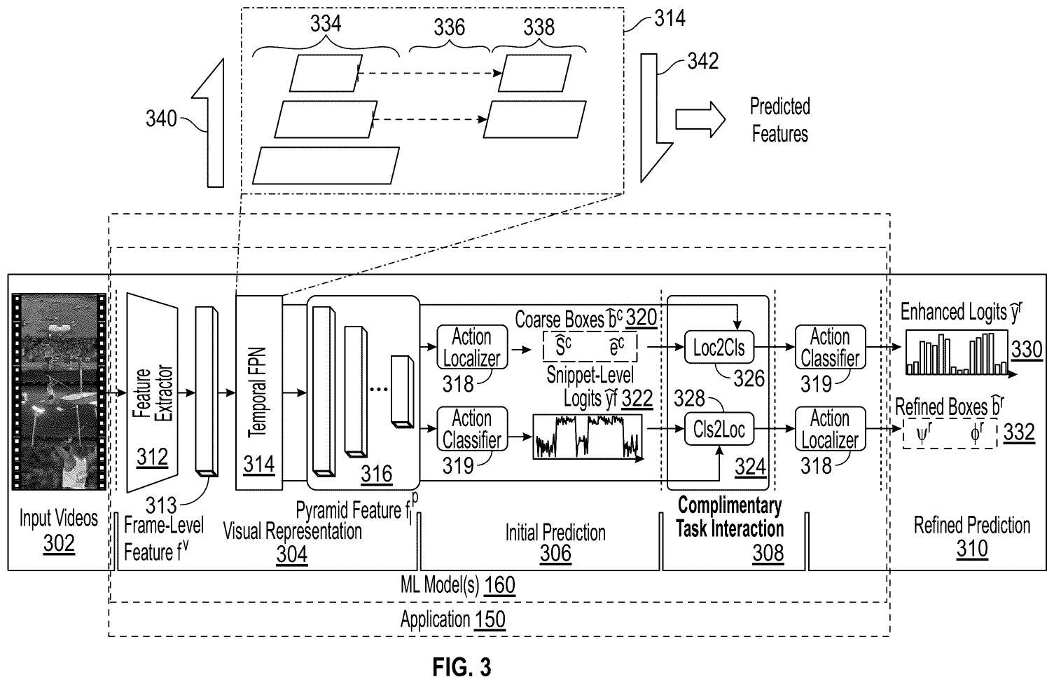

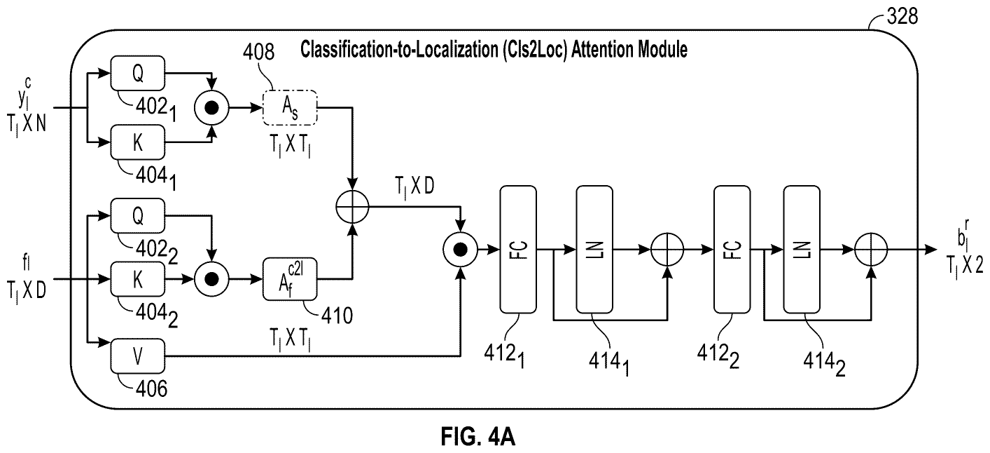

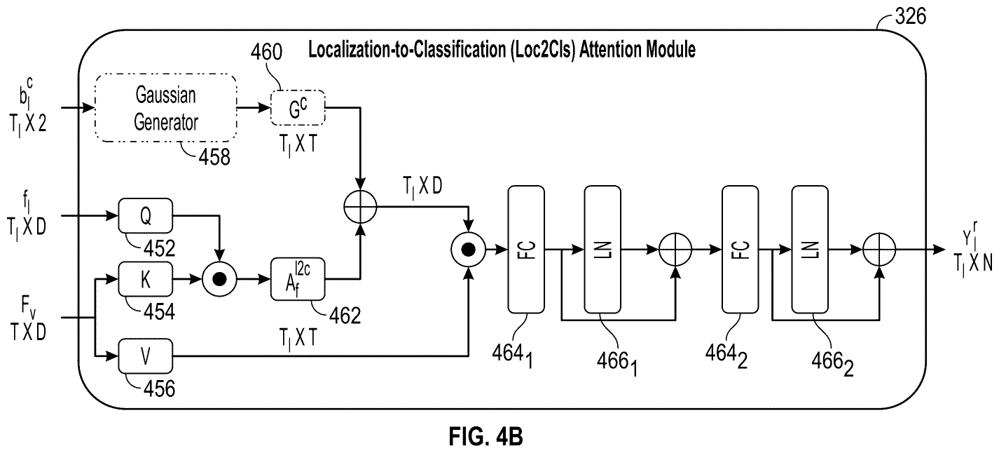

In one embodiment, the refined time-extent prediction is based further on the initial action-type classification. Additionally or alternatively, the refined action-type classification is based further on the initial time-extent prediction. The classification-to-localization attention module 236 constitutes a feedback mechanism for the initial action-type classification to be used to refine the time-extent prediction. The localization-to-classification attention module 238 constitutes a feedback mechanism for the initial time-extent prediction to be used to refine the action-type classification. The components 230 are further described in conjunction with FIGS. 3 and 4A-4B.

As shown in FIG. 2B, a video 252 includes a video segment depicting a pole vault during a time extent defined by a starting timestamp and an ending timestamp. In this particular example, the starting timestamp is one hundred and sixty-one and four-tenths seconds from a reference point of the video 252 such as a beginning of the video 252. The ending timestamp is one hundred and sixty-seven seconds from the reference point of the video 252. The actual information regarding the video segment depicting the pole vault and further regarding the time extent of the video segment constitute the ground truths 254 in this example.

In the absence of bidirectional feedback, the application can determine a classification 256, of the desired action, that is inaccurate insofar as a beginning of the pole vault is misclassified as being a javelin throw. In addition, the application can determine a time extent 258 of the action depicted in the video. In some embodiments, the time extent 258 is made available to the application via the bidirectional feedback mechanism between application components for temporal localization and action classification, respectively.

With bidirectional feedback using the feedback mechanisms described in conjunction with FIG. 2A, the application in FIG. 2B can use the time extent 258 as input to generate a refined classification 260. Unlike the classification 256, the refined classification 260 of the depicted action as being a pole vault is accurate when measured against the ground truth. Depending on the embodiment, the refinement of the classification can be performed either as an explicit operation or as an implicit operation, by the application. If the classification is performed as an implicit operation, the application determines, in a single determination, the refined classification 260 without first explicitly determining the classification 256. Similarly, the time extent 258 that is used as input can be either an explicit time extent or an implicit time extent, depending on the embodiment.

FIG. 3 is a block diagram depicting operational stages and components of the application 150 for action detection using machine learning, according to one embodiment presented in this disclosure. As shown, the operational stages include a first stage 302 of receiving one or more input videos, a second stage 304 of visual representation, a third stage 306 to generate initial predictions in the form of a type and a time extent for a depicted action, and a fourth stage 308 of complementary interaction, and a fifth stage 310 to refine the predictions.

In some embodiments, the components of the application 150 constitute those of the one or more machine learning models 160. As shown, the components include a feature extractor 312, a temporal feature pyramid network (FPN) component 314, an action classification and localization component, and a complementary interaction component 324. In some embodiments, some or all of these components can be further divided into subcomponents. For instance, the classification and localization component can be further dividable into a classification subcomponent and a localization subcomponent. In one embodiment, the classification subcomponent constitutes an action classifier 319, whereas the localization subcomponent constitutes an action localizer 318. In alternative embodiments, however, some or all of these components are not further dividable into any subcomponents.

In one embodiment, the feature extractor 312 is configured to receive video as input and extract features from the video, where the features can be frame-level features 313, denoted as f^{v} in FIG. 3. In some embodiments, the feature extractor can broadly constitute any three-dimensional (3D) video classification networks, such as Inflated 3D Networks (I3D). Further, the temporal FPN component 314 constitutes a type of feature extractor that takes as input a single-scale image, and/or the frame-level features associated therewith, and outputs feature maps at different levels of a pyramid-like structure. Such a pyramid-like structure contains pyramid features 316, denoted as fₗ^{p} in FIG. 3 and further described below. The feature maps corresponding to downscaled versions of the image, where the downscaled versions and the image together also constitute a pyramid-like structure. A single-scale image refers to a source image that is not accompanied by any rescaled versions of the source image when provided as input to the temporal FPN component 314. A detailed view of the temporal FPN component 314 is also provided.

As shown in the detailed view, the temporal FPN component 314 contains a first pyramid 334 that includes the single-scale image at a base layer of the pyramid 334. The first pyramid 334 also includes versions of the single-scale image that are downsampled to a successively greater degree, at upper levels of the pyramid 334. The downsampling can be performed via downsampling operations of a bottom-up pathway 340. In one embodiment, the bottom-up pathway 340 includes a feed-forward neural network. The temporal FPN component 314 also contains a second pyramid 338 of feature maps generated via successive upsampling and corresponding to some or all of the levels of the first pyramid 334. The upsampling can be performed via upsampling operations of a top-down pathway 342. The temporal FPN component 314 also includes lateral connections between the first and second pyramids 334, 338.

In one embodiment, the top-down pathway includes a convolutional neural network (CNN). The CNN performs upsampling based on input that includes features that are spatially coarser than desired output from the CNN. The upsampling is performed based further on input, via the lateral connections, that includes features having a measure of granularity that is finer than the spatially coarser features. The temporal FPN component 314 generates output in the form of the pyramid features 316.

The action classification and localization component includes the action localizer 318, which takes as input the pyramid features 316 and generates an initial classification. In one embodiment, the initial classification can be represented in the form of classification logits such as snippet-level logits 322. The action classification and localization component also includes the action classifier 319, which generates an initial prediction as to a time extent of a video segment associated with the initial classification. In one embodiment, the initial prediction as to the time extent can be represented in the form of boundary boxes, where the boundary boxes can be of a coarser measure of granularity than boundary boxes obtained after refinement.

In one embodiment, the process of refinement includes complementary interaction as performed by the complementary interaction component 324. In the refinement, the initial classification is refined by the action classifier 319 and based on the initial prediction as to the time extent, to yield a refined classification. The refined classification can be in the form of classification logits such as enhanced logits 330. Additionally or alternatively, the process refinement includes the initial prediction, as to the time extent, being refined by the action localizer 318 and based on the initial classification, to yield a refined prediction as to the time extent. In one embodiment, the refined prediction as to the time extent can be represented in the form of boundary boxes such as refined boxes 332. Together, the refined classification and the refined prediction constitute outputs of the fifth stage 310 of prediction generation.

Depending on the embodiment, any number of rounds of refinement can be performed. For instance, the refinement of the initial classification and of the initial prediction can together constitute a first round of refinement, and a second round of refinement can then be performed using the refined predictions as input to yield further-refined predictions. In an alternative embodiment, only a single round of refinement is performed, and the refined predictions are not further refined. Still alternatively, the number of desired rounds of refinement can be dynamically determined and set based on confidence scores that are determined by the application and that are associated with predictions last generated by the application, e.g., predictions generated during a last round of refinement by the application. Additionally or alternatively, the number of desired rounds of refinement can be dynamically determined based on other criteria such as utilization metrics including processor utilization, memory utilization, network utilization, and so on.

In one embodiment, the initial classification contains semantic category information and has an associated confidence score. Further, the initial prediction as to the time extent contains temporal scope information of the depicted action. In adopting the complementary interaction, the initial classification provides, for purposes of temporally localizing the depicted action, the semantic category information and the associated confidence score at a current time step. Further, the initial prediction as to time extent provides, for purposes of classifying the type of the depicted action, the temporal scope information of the depicted action. Doing so facilitates extracting features in a manner that exhibits a greater measure of awareness of locations that temporally neighbor the features, and these features can yield improved accuracy in classifying the type of the depicted action.

One alternative approach is a two-stage approach that decomposes temporal action localization into two stages: proposal generation and classification. The two-stage approach includes independently performing each of localization and classification in a respective one of two stages. Another alternative approach is a one-stage approach that includes performing, in parallel, proposal generation and classification based on a single model. Regardless of which of these alternative approaches are adopted, it is conceivable that graphical information contained in the video is accounted for while failing to consider implicit information contained in results obtained from localization and classification, respectively. Because localization and classification can constitute complementary machine-learning tasks, each result obtained from one of localization and classification is usable to refine a respective result obtained from the other of localization and classification. These machine-learning tasks can also be referred to herein as machine-learning subtasks in a broader context of temporal action localization. In this way, the techniques disclosed herein enable interaction and influence between components that perform these machine-learning subtasks of localization and classification.

Characteristics of classification results, such as continuity and mutation, that pertain to a predicted video segment that temporally neighbors a predicted boundary box can guide the model to adjust the boundary box. In one scenario, the classification results pertain to a predicted video segment that temporally neighbors the boundary box, and further, the classification results classify the pixels of the video frame as a foreground rather than as a background of a scene depicted in the video frame. In response to this scenario, the application can adjust the boundary box outward so that the boundary box is, to a lesser extent, erroneously inside of the actual video segment that can constitute a ground truth.

In an alternate scenario, the classification results pertain to a predicted video segment that temporally neighbors the boundary box, and further, the classification results classify the pixels of the video frame as a background rather than as a foreground of a scene depicted in the video frame. In response to this alternative scenario, the application can adjust the boundary box inward so that the boundary box is, to a lesser extent, erroneously outside of the actual video segment that can constitute a ground truth.

At least in some embodiments, the classification results can guide refinement of the localization, because contextual information implicit in the classification results can yield improved localizations with greater associated confidence scores. Further, the localization results can guide refinement of the classification because the classification can be guided to place a greater emphasis on content in the predicted boundary boxes, thereby reducing a measure of classification interference caused by background noise.

FIGS. 4A-4B depict components that enable a bidirectional feedback mechanism between a predicted action type and a predicted time extent for the depicted action, according to one embodiment presented in this disclosure. The components include a first component that provides an initial classification as input for purposes of refining localization. The first component can be the classification-to-localization attention module 328 previously described herein. The components also include a second component that provides an initial localization as input for purposes of refining classification. The second component can be the localization-to-classification attention module 326 previously described herein.

In one embodiment, the application takes output logits from a classification branch of the one or more machine learning models and provides the logits as input to the classification-to-localization attention module 328. The logits that are provided as input serve as additional information to guide the one or more machine learning models to adjust predicted boundary boxes to attain a greater measure of accuracy of the boundary boxes as measured against ground truths.

Further, the application takes predicted boundary boxes from a localization branch of the one or more machine learning models and provides the predicted boundary boxes as input to the localization-to-classification attention module 326. The predicted boundary boxes that are provided as input serve to guide the one or more machine learning models model to take into account, to a greater degree, content in the predicted boundary boxes. Doing so can reduce interference of background noise from the input video and yield classifications with a greater measure of accuracy as measured against ground truths.

In one embodiment, given an untrimmed video V={xₜ}ₜ₌₁^{T}^{ₑ} with Tᵥ frames, the application is configured to generate an action-type classification and a time-extent prediction for each of a set of actions depicted in the untrimmed video. The set of actions has M actions and is denoted as [symbol] ={aₘ|aₘ=(yₘ,bₘ)}ₘ₌₁^{M}, where yₘ is the action type of the m-th action instance, and where bₘ=(sₘ, eₘ) is the corresponding boundary box composed of start time sₘ and end time eₘ. The total number of action types is denoted by N. In some embodiments, the action type and the boundary box constitute a triplet that represents a corresponding action instance.

Further, the visual feature sequence of the given video extracted by a pre-trained model is f^{v}∈R^{(T×D)}, where T is the temporal length of the feature sequence, and where D is the feature dimension. The pre-trained model can be a CNN such as Two-Stream Inflated 3D ConvNets (I3D). In alternative approaches, the fᵥ is taken as input into the temporal FPN component to extract multi-scale pyramid features F^{p}={fₗ^{p}|fₗ^{p}∈ [symbol] ^{T}^{₁}^{×D}}ₗ₌₁^{L}, where f̅ₗ^{p̅} is the l-th feature, and where T₁ is the length of f̅ₗ^{p̅}. The alternative approaches use only the visual feature f^{v} to independently perform the two subtasks of localization and classification. Each level f̅ₗ^{p̅} of the pyramid features is further used to predict a localization result sequence \hat{B}ᵢ^{e}={b̅ₛ^{e}|\hat{b}ₛ^{e}=(\hat{ψ}ₛ^{c},\hat{ϕ}ₛ^{c})}ₛ₌₁^{T}^{₁}, where (\hat{ψ}ₛ^{c}, \hat{ϕ}ₛ^{c}) denote the start time and end time of the s-th predicted boundary box. This further results in a classification result sequence Ŷₗ^{c}={ŷₛ^{c}|ŷₛ^{c}∈ [symbol] ^{N}}ₛ₌₁^{T}^{ₜ}, where ŷₛ^{c} denotes classification scores predicted at the s-th predicted boundary box, and where N is the number of classes. Initial prediction can be formulated as:

$$\text{?} \text{?} = \text{?} ( V ) \text{?}$$

$$\text{?} \text{?} = \{ \text{?} \text{?} \vert \text{?} \text{?} = \text{?} \text{?} ( \text{?} \text{?} ) \} \text{?} \text{?}$$

$$\text{?} \text{?} = \{ \text{?} \text{?} \vert \text{?} \text{?} = \text{?} \text{?} ( \text{?} ) \text{?} \text{?}$$

$$\text{?} \text{indicates text missing or illegible when filed}$$

where Θ represents the composite function of the pre-trained model and FPN, and where ρ^{p} and γ^{p} denote, respectively, the action localizer and the action classifier at a stage of initial classification and initial prediction.

Subsequently, the results of the two tasks are used as complementary information to refine the results as part of a mechanism of complementary task interaction. The complementary task interaction is facilitated by two components, such as the classification-to-localization attention module 328 and the localization-to-classification attention module 326.

In one embodiment, the classification-to-localization attention module 328 of FIG. 4A facilitates localization based on classification results and includes fully connected layers 412 and layer-normalization components 414. This technique is motivated by characteristics, of video segments being classified, that can guide localization; an example characteristic is a measure of action, also referred to as “actionness,” associated with a video segment being classified. The classification results contain category information that can help distinguishing different actions from one another when predicting boundary boxes for the video segment.

This technique is further motivated by a desire to take into account that time points in the video segment that have similar classification logits contain content that is highly correlated with one another. The technique includes a self-attention mechanism that aggregates information from features with similarity scores satisfying a threshold similarity. Further, classification logits can be used to generate similarity scores, where time points of content with greater similarity to one another have higher similarity scores generated.

The classification similarity scores and the feature similarity scores are added to guide the one or more machine learning models to take into account, to a greater degree, content instances that bear a greater measure of semantic similarity with one another. The feature having the greatest degree of feature activity, also referred to as the attended feature, is then used to predict refined localization results bₗ^{r}.

An attention mechanism is performed with pyramid feature fₗ as a query 402 and with fᵥ as both a key 404 and a value 406. A similarity score of the query 402 and the key 404 is calculated as an attention score A_{f}∈R^{(B×P×T)}, where A_{f} is denoted as A_{f}^{c2l} 410. The attention score is also referred to as an attention weight. Further, self-similarity scores of the classification result sequence is calculated as the attention score A_{c}∈R^{(B×P×T)}, where A_{c} is denoted as Aₛ 408. Addition of Aₛ and A_{c} is performed to produce A and to cause the one or more machine learning models to take into account, to a greater degree, content having a higher likelihood of satisfying a relevance criterion. Multiplication is then performed between A and Fₚ to obtain f_{loc}. In the context of localization prediction and supervision, the f_{loc} is used to predict refined classification results B^{r}. When the mean-squared-error loss for Y^{r} is calculated, the cross-entropy loss of classification results Y^{c} is used as a weight to increase a given weight of the result as guided by the classification results.

In this way, feature correlation A_{f}^{2l} and semantic correlation Aₛ are computed from pyramid features and classification logits, respectively. These correlation scores are then fused to obtain an attention score, which causes the machine learning model to learn both visually related and semantically sensitive features.

In some embodiments, each feature is projected from an individual level of the pyramid into queries, keys, and values and compute correlation scores A_{f}^{c2l} of video content:

$$\text{?} \text{?} = softmax ( \frac{Q \text{?} K \text{?}}{\sqrt{D}} ) \text{?}$$

$$Q \text{?} = \text{?} \text{?} W \text{?} \text{?} K \text{?} = \text{?} \text{?} W \text{?} \text{?}$$

$$\text{?} \text{indicates text missing or illegible when filed}$$

where W_{qf}^{c2l}∈ [symbol] ^{D×D}, W_{kf}^{c2l}∈ [symbol] ^{D×D} are learnable parameters, and where D is the feature dimension.

Further, content with similar classification logits can be highly correlated. Thus, in addition to computing correlations between video content using visual features, classification results Y^{c} can be introduced to compute semantic correlation scores Aₛ by calculating:

$$A \text{?} = softmax ( \frac{Q \text{?} K \text{?}}{\sqrt{N}} ) \text{?}$$

$$Q \text{?} = Y \text{?} W \text{?} K \text{?} = Y \text{?} W \text{?} \text{?}$$

$$\text{?} \text{indicates text missing or illegible when filed}$$

where W_{qs}∈ [symbol] ^{N×N}, Wₖₛ∈ [symbol] ^{N×N} are learnable parameters, and where N is the number of action types. Then, feature-level correlation scores A_{f} and semantic correlation scores Aₛ are fused by addition.

In one embodiment, the fused attention score is used to cause the machine learning model to take into account, to a greater degree, content deemed as being highly related while paying heed to semantic category information, by computing: similarity.

$$\text{?} \text{?} \text{?} = ( \text{?} \text{?} + \text{?} \text{?} ) V \text{?}$$

$$V = \text{?} \text{?} \text{?} W \text{?} \text{?} \text{?}$$

$$\text{?} \text{indicates text missing or illegible when filed}$$

where Wᵥ^{c2l} are the learnable parameters to project visual features to value features. The interacted localization feature fₗ^{loc} is used to predict refined localization results from Bₗ^{r} in the stage of prediction refinement.

In one embodiment, the localization-to-classification attention module 326 of FIG. 4B facilitates refining classifications based on localization results and includes fully connected layers 464 and layer-normalization components 466. The localization results can guide the model to focus more on the content in the predicted boundary boxes, thereby reducing the interference caused by the background noise content. The technique includes a self-attention mechanism that aggregates information from features with similarity scores satisfying a threshold similarity.

Further, Gaussian scores are generated as the weights to aggregate information from other time points of the predicted video segment. The similarity scores inside the boundary boxes are higher than the similarity scores for other areas. The further away the time point is from the center of the prediction box, the lower the similarity score of the instant time point. The Gaussian scores and the similarity scores are added to guide the one or more machine learning models to take into account, to a greater degree, on content within the predicted video segments. The attended feature with Gaussian scores is then used to predict refined classification results yₗ^{r}.

In one embodiment, to generate the Gaussian scores, the predicted boundary boxes B^{c}={bₗ^{c}=(sₗ^{c}, eₗ^{c})}₍ₗ₌₁₎^{L} are transformed by a Gaussian generator 458 into the form of (center, duration), i.e., B^{c}={bₗ^{c}=(cₗ^{c}, dₗ^{c})}₍ₗ₌₁₎^{L}, where sₗ^{c}, eₗ^{c}, cₗ^{c}, dₗ^{c} are the start, end, and center time points and time extent of the predicted boxes, respectively. Further, cₗ^{c} and (dₗ^{c})/λ are used as parameters μ and σ in Gaussian formulation, where λ is a scaling factor. Gaussian score sequences gₗ^{c}∈R^{(B×T×1)} are generated for predicted boundary boxes bₗ^{c}. As a result, in gₗ^{c}, the similarity scores inside the boundary boxes are higher than similarity scores in other areas, Moreover, the further away the time point is from the center of the prediction box, the lower the similarity score of the time point. The Gaussian score sequences for all of the predicted boxes are concatenated into G^{c}∈R^{(B×P×T)}, where G^{c} is denoted as G^{c} 460.

In one embodiment, an attention mechanism guided by localization results is performed with pyramid feature fₗ as a query 452 and with fᵥ as both a key 454 and a value 456. A similarity score of the query 452 and the key 454 is calculated as the attention score Aₛ∈R^{(B×P×T)}, where Aₛ can also be denoted as A_{f}^{l2c} 462. Addition of Aₛ and G^{c} is performed to produce A and to cause the one or more machine learning models to take into account, to a greater degree, content that is within the boundary boxes. Then, matrix multiplication is performed between A and fᵥ to obtain f_{cls}. In the context of classification prediction and supervision, f_{cls} is used to predict refined classification results Y^{r}. When the cross-entropy loss for Y^{r} is calculated, a temporal Intersection-over-Union (tIoU) between coarser boundary boxes and ground-truth boundary boxes is used as a weight to increase a given weight of the result as guided by the boundary boxes. Further, the predicted tIoU Q^{c} is used in an inference stage to increase a given weight of the result as guided by the boundary boxes.

In this way, the Gaussian scores are obtained via boundary boxes to cause the machine learning model to take into account, to a greater degree, content within boundary boxes, which alleviates interference from background content of limited relevance. The attention score is computed by fusing the Gaussian and attention scores. An output attentive feature is derived from the l-th layer of the pyramid as fₗ^{loc} and fₗ^{cls}.

In some embodiments, visual features are projected into query features and key features, to compute feature-level correlation scores. Because localization results represent boundary information about actions, these localization results constitute information of at least moderately fine granularity. If the localization results are used to guide the classification feature to aggregate the pyramid feature fₗ^{p}, the boundary information can be lost or insufficiently exploited in coarser-level features.

As such, frame-level features f^{v} extracted by I3D as key features and value features are used to facilitate exploitation, at least to an extent deemed adequate, of the boundary information of the localization results. In particular, feature-level correlation scores are computed via the following:

$$A \text{?} = softmax ( \frac{Q \text{?} K \text{?}}{\sqrt{D}} ) ,$$

$$Q \text{?} = \text{?} \text{?} W \text{?} \text{?} K \text{?} = f \text{?} W \text{?} \text{?}$$

$$\text{?} \text{indicates text missing or illegible when filed}$$

where W_{qf}^{l2c}∈ [symbol] ^{D×D} and W_{kf}^{l2c}∈ [symbol] ^{D×D} are learnable parameters. The scope information from the localization results is then used to guide the machine learning model to take into account, to a greater degree, the content within the predicted boundary boxes.

Intuitively speaking, the most discriminative content for classification is distributed around the center of the action depicted in the video. Further, the internal content of boundary boxes yields confidence scores of a measure of reliability that can satisfy at least a moderate threshold of reliability. Using the localization results, Gaussian kernels are generated to perform a localization-to-classification interaction. The weights of a Gaussian kernel gₛ^{c} for a boundary box bₛ^{c} are defined as follows:

$$\text{?} \text{?} \text{?} [ \text{?} ] = \frac{1}{Z} exp ( - \frac{( \text{?} μ \text{?} \text{?} )}{2 σ \text{?} \text{?} 2} ) \text{?}$$

$$\text{?} \text{?} μ \text{?} \text{?} = \frac{\text{?} \text{?} \text{?}}{2} , σ \text{?} = \text{?} \text{?} - \text{?} \text{?} \text{?}$$

$$\text{?} ∈ \{ 0 , 1 , \text{?} , T \} \text{?}$$

$$\text{?} \text{indicates text missing or illegible when filed}$$

where Z is the normalization factor, Φₛ^{c} and ψₛ^{c} and are the predicted starting and ending timestamps of the predicted time extent of the video segment, and T is the sequence length.

Using the Gaussian kernel, the weights inside the action are greater in measure than the weights outside the action, according to one embodiment. Further, the weights for temporal locations farther from the center of the action are lesser in measure. The feature-level attention score and the Gaussian kernel are fused to cause the machine learning model to take into account, to a greater degree, the content within predicted boundary boxes while simultaneously perceiving a global context associated with the video.

In one embodiment, the pyramid classification features are guided by the localization results via a calculation given by:

$$\text{?} \text{?} = ( A \text{?} + G \text{?} ) V ,$$

$$V = f \text{?} W \text{?} , G \text{?} = [ \text{?} \text{?} \text{?} \text{?} \text{?} \text{?} ⋯ \text{?} \text{?} \text{?} ] \text{?} ]$$

$$\text{?} \text{indicates text missing or illegible when filed}$$

where Wᵥ^{l2c} are learnable parameters to generate value features, where Gₗ^{c} are Gaussian kernels for boundary boxes at l-th level, and where [;] denotes a concatenation operation. The interacted classification feature fₗ^{cls} is then provided as an input to the classification module to obtain classification results Yₗ^{r} of a greater measure of reliability.

In view of the foregoing, at least in some embodiments, the complementary task interaction between the two tasks can be formulated as follows:

F^{cls}=Loc2Cls(B^{c},F^{p}),

F^{loc}=Cls2Loc(Y^{c},F^{p},f^{υ}),

where F^{cls}={fₗ^{cls}}ₗ₌₁^{L} and F^{loc}={fₗ^{loc}}ₗ₌₁^{L} constitute the collection of attentive features from the two blocks, Loc2Cls and Cls2Loc. Then, in the refinement process, the refined boundary boxes and refined classifications are calculated via:

$$\text{?} \text{?} = \text{?} \text{?} \text{?} \vert \text{?} \text{?} = \text{?} \text{?} ( \text{?} \text{?} ) \} \text{?} \text{?}$$

$$\text{?} \text{?} = \text{?} \text{?} \text{?} \vert \text{?} \text{?} = \text{?} \text{?} ( f \text{?} ) \} \text{?} ,$$

$$\text{?} \text{indicates text missing or illegible when filed}$$

where ρ^{r} and γ^{r} are the action localizer and the action classifier, respectively, in a stage of refinement.

In some embodiments, refinement can be impaired to the extent that initial results have a measure of accuracy below a threshold. To address this scenario, a quality-weighted loss function can be used. The refined-classification loss function between refined classification results and ground-truth labels can be defined as:

$$\text{?} \text{?} ( \text{?} ) = \text{?} + \text{?} \text{?}$$

$$\text{?} = \frac{1}{N \text{?}} \sum \text{?} \text{?} ( \text{?} \geq 1 ) λ \text{?} \text{?} \text{?} E ( \text{?} \text{?} \text{?} ) \text{?}$$

$$\text{?} = \frac{\sum \text{?} λ \text{?}}{N \text{?} N \text{?}} \sum \text{?} \text{?} ( \text{?} < 1 ) L \text{?} ( \text{?} \text{?} \text{?} ) \text{?}$$

$$\text{?} \text{indicates text missing or illegible when filed}$$

where Nₚ and Nₙ denote the number of positive samples and negative samples, respectively, where II(⋅) is the indicator function, and where “BCE” represents a binary cross-entropy (BCE) loss function. The tIoU λₛ^{c} between the initial boundary box and the corresponding ground truth is used to measure the quality of localization results in a stage of initial prediction. The measured quality is then used as a weight for classification loss in a stage of prediction refinement. Because the TIoU is only for positive samples, the average of tIoU for positive samples is used as the weight for negative samples to perform a tradeoff between the two types of samples.

As for the localization loss in the stage of prediction refinement, the classification score of the ground-truth label from the stage of initial prediction is used. In particular, the loss between bₛ^{r} and ground truth b^{s} is defined as:

$$\text{?} \text{?} ( \text{?} ) = \frac{1}{N} \text{?} \sum \text{?} ( \text{?} \geq 1 ) softmax ( \text{?} ) [ \text{?} ] L \text{?} ( \text{?} \text{?} ) \text{?}$$

$$\text{?} \text{indicates text missing or illegible when filed}$$

where L₁ is the L1 loss function. The losses between localization results, classification results, and the corresponding ground truth are determined via a normal L1 loss function and a BCE loss function.

In one embodiment, the normal L1 loss function and the BCE loss function can be formulated as:

$$\text{?} \text{?} ( \text{?} ) = \frac{1}{N} \text{?} \sum \text{?} ( \text{?} \geq 1 ) L \text{?} ( \text{?} \text{?} ) \text{?}$$

$$\text{?} \text{?} ( Y \text{?} ) = \frac{1}{N} \text{?} \sum \text{?} \text{?} \text{?} \text{?} ( \text{?} \text{?} ) \text{?}$$

$$\text{?} \text{indicates text missing or illegible when filed}$$

where Nₐ=Nₚ+Nₙ is the number of all samples. The technique of complementary task interaction can conduct learning with an action localizer and an action classifier, of the stage of initial prediction, in an end-to-end manner. The total loss function can then be defined as:

$$\text{?} = \text{?} \text{?} + \text{?} \text{?} + \text{?} \text{?} + \text{?} \text{?} .$$

$$\text{?} \text{indicates text missing or illegible when filed}$$

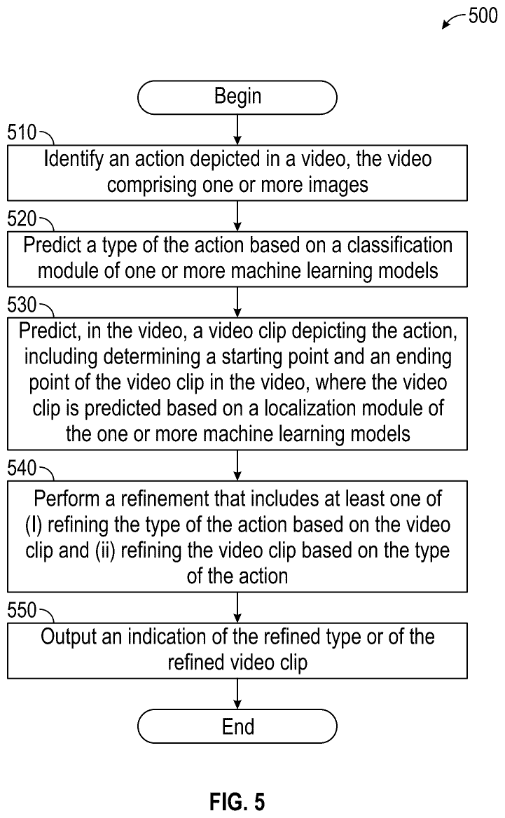

FIG. 5 is a flowchart depicting a method 500 of video processing for action detection using machine learning, according to one embodiment. The method 500 can be performed by the application 150 of FIG. 1 in conjunction with the one or more machine learning models 160 of FIG. 1. In some embodiments, the one or more machine learning models have been trained over a set of training data and using supervised or unsupervised learning techniques. The training data includes input videos and, in the case of supervised learning techniques, further includes ground-truth classifications and time extents for video segments in the input videos. The one or more machine learning models are trained until the one or more machine learning models can be validated as exhibiting a measure of classification accuracy that satisfies a threshold measure of accuracy.

As shown, the method 500 begins at step 510, wherein the application 150 identifies an action depicted in a video. The video includes one or more images. At step 520, the application 150 predicts a type of the action using a classification module of one or more machine learning models. At step 530, the application 150 predicts, in the video, a video clip depicting the action. Predicting the video clip includes determining a starting point and an ending point of the video clip in the video. Further, the video clip is predicted using a localization module of the one or more machine learning models. At step 540, the application 150 performs a refinement that includes refining the type of the action based on the video clip. Additionally or alternatively, the refinement includes refining the video clip based on the type of the action. At step 550, the application 150 outputs an indication of the refined type or of the refined video clip. After the step 550, the method 500 terminates.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages discussed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

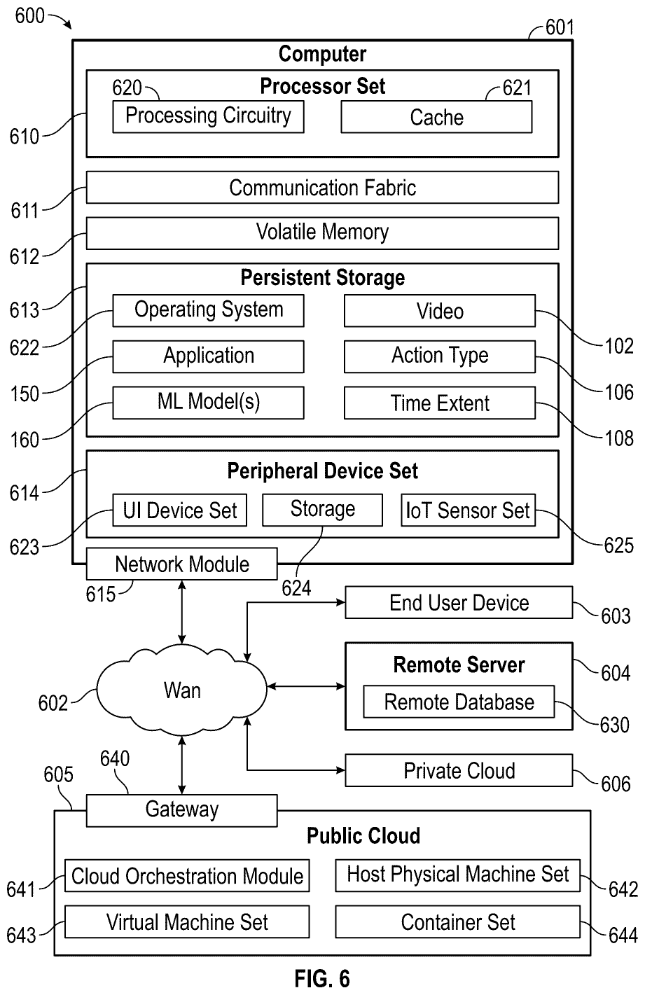

FIG. 6 is a block diagram illustrating components of a computing environment 600 for video processing for action detection using machine learning, according to one embodiment. The application 150 processes the video 102 using one or more machine learning models 160 to classify the action type 106 and predict the time extent 108 of an action depicted in the video 102. Computing environment 600 contains an example of an environment for the execution of at least some of the computer code involved in performing the inventive methods, such as the application 150. In addition to the application 150, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and the application 150, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in the application 150 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 103 typically receives helpful and useful data from the operations of computer 601. For example, in a hypothetical case where computer 601 is designed to provide a recommendation to an end user, this recommendation would typically be communicated from network module 615 of computer 101 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

While the foregoing is directed to embodiments of the present invention, other and further embodiments of the invention may be devised without departing from the basic scope thereof, and the scope thereof is determined by the claims that follow.

What is claimed is:

1. A computer-implemented method of video processing for action detection using machine learning, the computer-implemented method comprising:
identifying the action depicted in the video, the video comprising one or more images;
predicting a type of the action based on a classification module of one or more machine learning models;
predicting, in the video, a video clip depicting the action, including determining a starting point and an ending point of the video clip in the video, wherein the video clip is predicted based on a localization module of the one or more machine learning models;
performing a refinement that includes at least one of (i) refining the type of the action based on the video clip or (ii) refining the video clip based on the type of the action, wherein the refinement is performed by one or more computer processors; and
outputting an indication of the refined type or of the refined video clip.

2. The computer-implemented method of claim 1, wherein refining the type of the action reclassifies the type of the action from a misclassification as being at least part of contiguous actions of two or more different types, to a corrected classification as being a single action of a single type.

3. The computer-implemented method of claim 1, wherein refining the video clip re-localizes the video clip from an incorrect localization as being a longer clip that depicts two or more contiguous actions, to a corrected localization as being a shorter clip that depicts a single action, wherein the longer and shorter clips are relative to one another in duration.

4. The computer-implemented method of claim 1, wherein the type of the action is refined by an attention module of the one or more machine learning models, the attention module comprising a localization-to-classification attention module.

5. The computer-implemented method of claim 1, wherein the video clip is refined by an enhancement module of the one or more machine learning models, the enhancement module comprising a classification-to-localization enhancement module.

6. The computer-implemented method of claim 1, wherein the refinement includes both of (i) refining the type of the action based on the video clip and (ii) refining the video clip based on the type of the action, wherein a bidirectional feedback mechanism is provided between the classification and localization modules, and wherein the bidirectional feedback mechanism is provided to increase a measure of accuracy of one or more machine learning models, the measure of accuracy pertaining to at least one of classification and localization.

7. The computer-implemented method of claim 6, wherein outputting the indication of the refined type or of the refined video clip comprises outputting indications of the refined type and of the refined video clip, respectively.

8. A computer program product of video processing for action detection using machine learning, the computer program product comprising:
a computer-readable storage medium having computer-readable program code embodied therewith, the computer-readable program code executable by one or more computer processors to perform an operation comprising:
identifying the action depicted in the video, the video comprising one or more images;
predicting a type of the action based on a classification module of one or more machine learning models;
predicting, in the video, a video clip depicting the action, including determining a starting point and an ending point of the video clip in the video, wherein the video clip is predicted based on a localization module of the one or more machine learning models;
performing a refinement that includes at least one of (i) refining the type of the action based on the video clip or (ii) refining the video clip based on the type of the action; and
outputting an indication of the refined type or of the refined video clip.

9. The computer program product of claim 8, wherein refining the type of the action reclassifies the type of the action from a misclassification as being at least part of contiguous actions of two or more different types, to a corrected classification as being a single action of a single type.

10. The computer program product of claim 8, wherein refining the video clip re-localizes the video clip from an incorrect localization as being a longer clip that depicts two or more contiguous actions, to a corrected localization as being a shorter clip that depicts a single action, wherein the longer and shorter clips are relative to one another in duration.

11. The computer-implemented method of claim 8, wherein the type of the action is refined by an attention module of the one or more machine learning models, the attention module comprising a localization-to-classification attention module.

12. The computer program product of claim 8, wherein the video clip is refined by an enhancement module of the one or more machine learning models, the enhancement module comprising a classification-to-localization enhancement module.

13. The computer program product of claim 8, wherein the refinement includes both of (i) refining the type of the action based on the video clip and (ii) refining the video clip based on the type of the action, wherein a bidirectional feedback mechanism is provided between the classification and localization modules, and wherein the bidirectional feedback mechanism is provided to increase a measure of accuracy of one or more machine learning models, the measure of accuracy pertaining to at least one of classification and localization.

14. A system of video processing for action detection using machine learning, the system comprising:
one or more computer processors; and
a memory containing a program executable by the one or more computer processors to perform an operation comprising:
identifying the action depicted in the video, the video comprising one or more images;
predicting a type of the action based on a classification module of one or more machine learning models;
predicting, in the video, a video clip depicting the action, including determining a starting point and an ending point of the video clip in the video, wherein the video clip is predicted based on a localization module of the one or more machine learning models;
performing a refinement that includes at least one of (i) refining the type of the action based on the video clip or (ii) refining the video clip based on the type of the action; and
outputting an indication of the refined type or of the refined video clip.

15. The system of claim 14, wherein refining the type of the action reclassifies the type of the action from a misclassification as being at least part of contiguous actions of two or more different types, to a corrected classification as being a single action of a single type.

16. The system of claim 14, wherein refining the video clip re-localizes the video clip from an incorrect localization as being a longer clip that depicts two or more contiguous actions, to a corrected localization as being a shorter clip that depicts a single action, wherein the longer and shorter clips are relative to one another in duration.

17. The system of claim 14, wherein the type of the action is refined by an attention module of the one or more machine learning models, the attention module comprising a localization-to-classification attention module.

18. The system of claim 14, wherein the video clip is refined by an enhancement module of the one or more machine learning models, the enhancement module comprising a classification-to-localization enhancement module.

19. The system of claim 14, wherein the refinement includes both of (i) refining the type of the action based on the video clip and (ii) refining the video clip based on the type of the action, wherein a bidirectional feedback mechanism is provided between the classification and localization modules, and wherein the bidirectional feedback mechanism is provided to increase a measure of accuracy of one or more machine learning models, the measure of accuracy pertaining to at least one of classification and localization.

20. The computer-implemented method of claim 19, wherein outputting the indication of the refined type or of the refined video clip comprises outputting indications of the refined type and of the refined video clip, respectively.
